(19) United States
(12) Patent Application Publication
(10) Pub. No.: US 2007/0193305 A1
(43) Pub. Date: Aug. 23, 2007

(54) Method for blending and recirculating deuterium-containing gas

(76) Inventors: Arthur I. Shirley, Hillsborough, NJ (US); Shuen-Cheng Hwang, Chester, NJ (US)

Correspondence Address: THE BOC GROUP, INC., 575 MOUNTAIN AVENUE, MURRAY HILL, NJ, 07974-2064, US

(21) Appl. No.: 11/650,371

(22) Filed: Jan. 5, 2007

Related U.S. Application Data
(63) Continuation-in-part of application No. 10/833,180, filed on Apr. 27, 2004, now abandoned.
(60) Provisional application No. 60/488,001, filed on Jul. 17, 2003.

(51) Int. Cl. F17D 1/00; C03B 37/07; C03B 37/018

(52) U.S. Cl. 65/377; 65/434; 65/424; 137/2

(57) ABSTRACT

A method for blending deuterium-containing gas mixtures used for optical fiber manufacturing and finishing and recovering, purifying and recirculating these mixtures. A process is disclosed for producing optical fiber wherein the optical fiber is treated by soaking the optical fiber with a deuterium-containing gas mixture. The spent or unused deuterium-containing gas is recovered from the chamber containing the optical fiber that has been soaked and purified. This purified deuterium-containing gas is then mixed with fresh deuterium gas and analyzed for purity. If the purity is of sufficient quality, the blend of deuterium gases is directed to a storage tank and onwards to the process chamber containing the optical fiber which will be soaked. Additionally, the purified blend of deuterium-containing gas and fresh deuterium gas can be added directly to the process chamber.

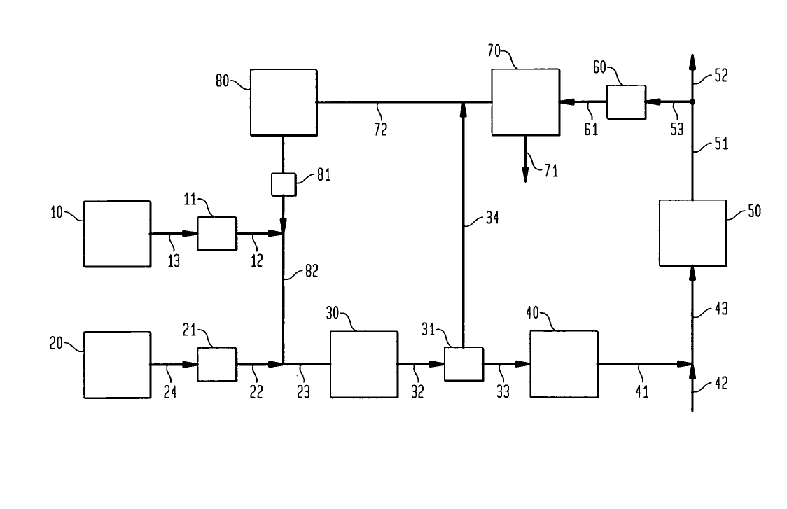

This application claims priority from U.S. Provisional Patent Application Ser. No. 60/488,001 filed Jul. 17, 2003, and from U.S. patent application Ser. No. 10/833,180, filed Apr. 27, 2004.

### BACKGROUND OF THE INVENTION

The present invention provides for a method for the blending, recovering, purifying and recirculating of deuterium-containing mixtures used for optical fiber manufacturing. The deuterium-containing gas mixtures are those that are used to soak the optical fiber after it has undergone production.

Glass optical fibers are customarily made from preforms that are fabricated using the chemical vapor deposition (CVD) of a silica precursor. The CVD process often employs an oxy-hydrogen flame as a heat source to promote the reaction of the precursor with oxygen. This is done either as a direct oxidation (where the flame is separated from the CVD reaction zone) or as a hydrolysis reaction (where the precursor and oxygen react inside the oxy-hydrogen flame). In either case water vapor may be present in the deposited silica, a result of the presence of moisture in the raw materials or the action of the oxy-hydrogen flame. This small amount of moisture is known to localize in the deposited silica at certain defect sites in the glassy matrix to a degree sufficient to cause small but measurable increases in fiber attenuation. This increase in attenuation will cause a loss of some of the transmission spectrum of the cable. Even if various drying steps in the production of the fiber remove the moisture, hydrogen in the environment surrounding the fiber will diffuse over time into the core of the fiber to create additional light attenuating centers.

One means to combat this increase in attenuation due to the presence of hydrogen in the fiber is the use of deuterium, an isotope of hydrogen containing an electron, a proton and a neutron. Like hydrogen, the deuterium will localize in the deposited silica at defect sites in the glassy matrix. Although this will again cause an increase in attenuation, the resonant peaks and their tails lie outside of the bands of the spectrum currently used for transmission. The presence of deuterium will prevent further uptake of hydrogen by the fiber, effectively making it “water-free” over its useful life.

Optical fiber can be treated or “soaked” with deuterium at two stages in fiber production: after the preform is deposited, and after the fiber is drawn. A typical treatment consists of exposing the preform or fiber to a quiescent mix of deuterium in an inert gas, usually 1-10% deuterium in nitrogen. The concentration of deuterium is important to the diffusional processes that allow the glass to take up deuterium, but very little of the deuterium in the mixture is incorporated in the glass. The balance of the gas used for treatment is vented and disposed of, representing a great cost in deuterium and an additional expense in fiber production.

As such, there is a need for improved processes for blending deuterium-containing gas mixtures used in soaking of optical fibers after the preform is deposited or after the fiber is drawn, as well as recovering, purifying and recycling them.

### SUMMARY OF THE INVENTION

The present invention provides for a process for blending deuterium-containing mixtures used for optical fiber manufacturing where the deuterium-containing gas mixture is used to soak the optical fiber and recovering, purifying and recirculating these deuterium-containing gas mixtures.

The present invention further provides for a process for producing optical fiber wherein the optical fiber is treated by soaking the optical fiber with a quiescent deuterium-containing gas mixture. The spent or unused deuterium-containing gas is recovered from the chamber containing the optical fiber and purified. This purified deuterium-containing gas is then mixed with fresh deuterium gas and analyzed for purity. If the purity is of sufficient quality, the blend of deuterium gases is directed to a storage tank and onwards to the process chamber containing the optical fiber.

The present invention further comprises a method for recovering from the quiescent soaking of an optical fiber and recirculating a deuterium-containing gas mixture from a fiber optic production process chamber, purifying and blending the with fresh deuterium gas, then adding this mixture directly to the process chamber.

As used herein, “deuterium-containing” means that the concentration of the deuterium in the gas mixture is from about 1 to about 100 percent by volume of deuterium.

### BRIEF DESCRIPTION OF THE DRAWINGS

The FIGURE is a schematic representation of a process for blending a deuterium-containing gas mixture.

### DETAILED DESCRIPTION OF THE INVENTION

A process for blending a deuterium-containing gas mixture for use in a fiber optic manufacturing process wherein the optical fiber is soaked in a quiescent deuterium-containing gas mixture comprising the steps:
(a) recovering the deuterium-containing gas mixture from the fiber optic production process chamber wherein said fiber optic production process chamber contains the deuterium-containing gas mixture and said optical fiber is soaked therein;
(b) purifying the deuterium-containing gas mixture;
(c) directing the purified deuterium-containing gas mixture to a storage vessel, wherein said purified deuterium-containing gas mixture resides until said process chamber requires deuterium-containing gas mixture;
(d) directing the purified deuterium-containing gas mixture from the storage vessel to an analyzer;
(e) blending fresh deuterium gas with the purified deuterium-containing gas mixture; and
(f) analyzing the combination of the deuterium-containing gas mixture and the deuterium gas.

The deuterium-containing gas mixture comprises deuterium and an inert gas. The inert gas is selected from the group consisting of argon, neon, krypton, xenon, helium or nitrogen or mixtures thereof, and is preferably nitrogen.

The analysis comprises the analysis of the combination of deuterium-containing gas mixture and the deuterium gas for purity of the combination. When there are no impurities in the combination, the combination is directed to a storage vessel for entry later into the process chamber wherein the optical fiber resides.

Where there are one or more impurities are present in the combination, the combination is directed to the purification unit. The purification unit preferably is a cold nitrogen gas stream to purify the combination but may also be an adsorptive, distillative, absorptive or membrane means of separation. The purified combination of deuterium gases is then directed to the storage vessel for later introduction into the fiber optic process chamber.

The present invention also provides for a process for producing optical fiber wherein the optical fiber is treated with deuterium-containing gas mixture comprising the steps:
(a) soaking the optical fiber in the deuterium-containing gas mixture in a process chamber;
(b) recovering the remainder of the deuterium-containing gas mixture from the process chamber;
(c) purifying the recovered deuterium-containing gas mixture and directing to a storage vessel wherein the purified deuterium-containing gas mixture resides until the process chamber requires a deuterium-containing gas mixture;
(d) blending fresh deuterium gas with the purified deuterium-containing gas mixture and directing the blended deuterium gas to an analyzer; and
(e) analyzing the purity of the blended deuterium gas and directing the blended deuterium gas to the process chamber, or for further purifying.

The deuterium-containing gas mixture is about 1 to about 10 percent deuterium, while the remainder is an inert gas as described above. The purification step also utilizes the cold nitrogen gas stream or an adsorptive, distillative, absorptive or membrane means of separation.

In the methods and processes of the present invention, the analyzer will analyze the blended deuterium containing gas mixture to determine the amount of impurities such as hydrocarbons and other by-products of the fiber optic production process. The analyzer is typically a mass spectrometry or thermo-analytical device. When the purity of this blended deuterium gas mixture reaches a pre-determined set point it can be directed back to the storage vessel and utilized later for soaking the optic fiber.

The present invention also further describes a method of recovering and recirculating a deuterium-containing gas mixture from a fiber optic production process chamber wherein the optical fiber is soaked in the deuterium-containing gas mixture in the fiber optic production process chamber comprising withdrawing the deuterium-containing gas mixture from the process chamber; purifying the deuterium-containing gas mixture; blending the purified deuterium with fresh deuterium gas; and adding the blend of the purified and fresh deuterium gas to the process chamber.

The advantages of this method is that the spent deuterium gas, which would otherwise be vented and wasted, can be purified and blended with fresh deuterium gas; and the deuterium containing gas can be then directed back to the fiber optic production process chamber and utilized for additional, or fresh soaking of the optical fiber.

Reference will now be made to the FIGURE where there is shown an embodiment that describes the basic operation of the present invention. For the initial startup of the process, the desired deuterium-containing mixture can be formulated by dynamic blending of deuterium from the deuterium storage tank 10 through line 13 to a mass flow control device 11 and through line 12 to line 82 with an inert gas, selected from the group consisting of argon, neon, krypton, xenon, helium or nitrogen, or mixtures thereof, from the inert gas storage tank 20 through line 24 to a mass flow control device 21 and through line 22 to join line 82. Mass flow controllers 11 and 21 or similar flow control devices can be used to adjust the individual gas flows through lines 12 and 22 respectively. The mixture is delivered through line 23 and sent to a deuterium analyzer 30. The analyzer can be an off-line or in-situ detector, and as depicted in the Figure is in-situ. If the mixture is off specification, it will be diverted to storage tank 80 through line 32 via a three-way valve 31 and line 34 to line 72 and onward to storage tank 80. If the mixture of gas has the correct specification, then it will be forwarded to storage tank 40 from line 32 via the three-way valve 31 and line 33 to be used in the manufacturing of optical fibers in process chamber 50.

The first storage tank 40 contains the deuterium gas mixtures that comprise the deuterium-containing gas mixture from the process chamber and fresh deuterium gas, all of sufficient purity to be transported through line 41 to line 43 for entry into the process chamber 50. Note that line 42 connects with lines 41 and 43 and represents purge of inert gas (not shown) from the inert gas tank 20. In an alternative embodiment of the present invention, storage tank 40 is not employed and the deuterium-containing gas mixture from the process chamber and fresh deuterium gas is directed immediately into the process chamber 50.

The deuterium-containing exhaust gas mixture from process chamber 50 which may contain impurities such as hydrocarbons and other compounds is directed through line 51 and line 53 and recovered by a pump 60 and forwarded to a suitable purification unit 70 through line 61 where any compounds other than deuterium and the desired inert gas are removed. Line 52 vents any other undesirable gases from the process cycle. If only impurities that have high freezing points are to be removed, a cold nitrogen gas stream can be used to provide the refrigeration required to freeze the impurities. Impurities are vented from the purification unit 70 through line 71. The purified gas is directed to the storage tank 80 through line 72 where it may also be joined by off specification deuterium-containing gas mixtures that have been analyzed through line 34. The purified deuterium-containing mixture is then stored in storage tank 80 for recirculation.

If the pressure in the process chamber 50 is less than that in the storage tank 80, a vacuum pump is necessary to recover the spent deuterium-containing mixture. Alternatively, the inert gas from the inert gas storage tank 20 can be used as a purge gas to recover deuterium from the process chamber 50. Once the deuterium-containing mixture is recovered in the storage tank 80, it can be used as a feed gas through line 82 and mass flow controller 81 to be blended with pure deuterium gas from storage tank 10 and with inert gas from storage tank 20 if necessary.

While this invention has been described with respect to particular embodiments thereof, it is apparent that numerous other forms and modifications of the invention will be obvious to those skilled in the art. The appending claims in this invention generally should be construed to cover all such obvious forms and modifications which are within the true spirit and scope of the present invention.

Having thus described the invention, what we claim is:

1. A process for blending a deuterium-containing gas mixture for use in a fiber optic manufacturing process wherein the optical fiber is soaked in a quiescent deuterium-containing gas mixture comprising the steps:
a) recovering said deuterium-containing gas mixture from said fiber optic production process chamber wherein said optical fiber is soaked in said deuterium-containing gas mixture;
b) purifying as necessary said deuterium-containing gas mixture;
c) directing said purified deuterium-containing gas mixture to a storage vessel, wherein said purified deuterium-containing gas mixture resides until said process chamber requires deuterium-containing gas mixture;
d) directing said purified deuterium-containing gas mixture from said storage vessel to an analyzer;
e) blending fresh deuterium gas with said purified deuterium-containing gas mixture; and
f) analyzing said combination of said deuterium-containing gas mixture and said deuterium gas.

2. The process as claimed in claim 1 wherein said deuterium-containing gas mixture comprises deuterium and an inert gas.

3. The process as claimed in claim 2 wherein said inert gas is selected from the group consisting of argon, neon, krypton, xenon, helium, nitrogen, and mixtures thereof.

4. The process as claimed in claim 1 wherein said analyzing comprises analysis of the combination of deuterium-containing gas mixture and said deuterium gas for purity of said combination.

5. The process as claimed in claim 4 wherein there are no impurities in said combination.

6. The process as claimed in claim 4 wherein one or more impurities are present in said combination.

7. The process as claimed in claim 6 where said combination is directed to a purification unit.

8. The process as claimed in claim 7 wherein said purification unit uses a cold nitrogen gas stream to purify said combination.

9. The process as claimed in claim 8 wherein said combination is directed to a storage vessel.

10. The method as claimed in claim 1 wherein said analyzer is selected from the group consisting of a mass spectroscopy analyzer and a thermal conductivity analyzer.

11. A process for producing optical fiber wherein said optical fiber is treated with deuterium-containing gas mixture comprising the steps:
a) soaking the optical fiber in said deuterium-containing gas mixture in a process chamber;
b) recovering said spent deuterium-containing gas mixture from said process chamber;
c) purifying as necessary said recovered deuterium-containing gas mixture and directing to a storage vessel, wherein said purified deuterium-containing gas mixture resides until said process chamber requires deuterium-containing gas mixture;
d) blending fresh deuterium gas with said purified deuterium-containing gas mixture and directing said blended deuterium gas to an analyzer;
e) analyzing the purity of said blended deuterium gas and directing said blended deuterium gas to said process chamber, or for further purifying.

12. The method as claimed in claim 11 wherein said deuterium-containing gas mixture is about 1 to about 10 percent deuterium by volume.

13. The method as claimed in claim 11 wherein said deuterium-containing gas mixture contains an inert gas.

14. The method as claimed in claim 13 wherein said inert gas selected from the group consisting of argon, neon, krypton, xenon, helium, nitrogen, and mixtures thereof

15. The method as claimed in claim 11 wherein said purifying is performed with a cold nitrogen gas stream.

16. The method as claimed in claim 11 wherein said analyzer is selected from the group consisting of a mass spectroscopy analyzer and a thermal conductivity analyzer.

17. A method of recovering and recirculating a deuterium-containing gas mixture from a fiber optic production process chamber wherein an optical fiber is soaked in deuterium-containing gas in said process chamber comprising withdrawing said deuterium-containing gas mixture from said process chamber; purifying said deuterium-containing gas mixture; blending said purified deuterium with fresh deuterium gas; and adding said blend of said purified deuterium with fresh said deuterium gas to said process chamber.

18. The method as claimed in claim 17 wherein said deuterium-containing gas mixture is about 1 to about 10 percent deuterium by volume.

19. The method as claimed in claim 18 wherein said deuterium-containing gas mixture contains an inert gas.

20. The method as claimed in claim 19 wherein said inert gas is selected from the group consisting of argon, neon, krypton, xenon, helium, nitrogen, and mixtures thereof.

21. The method as claimed in claim 17 wherein said blend of purified deuterium with fresh deuterium gas is analyzed for purity.

22. The method as claimed in claim 21 wherein said analyzed blend of purified deuterium with fresh deuterium gas is directed to a purifier for additional purification.

23. The method as claimed in claim 22 wherein said analyzed blend of purified deuterium with fresh deuterium gas is directed to said process chamber.

24. The method as claimed in claim 11 wherein said analysis is performed with an analyzer selected from the group consisting of a mass spectroscopy analyzer and a thermal conductivity analyzer.
